(19) United States
(12) Patent Application Publication
(10) Pub. No.: US 2020/0278006 A1
(43) Pub. Date: Sep. 3, 2020

(54) DAMPING PAD

(71) Applicant: Tie Li, Shenzhen (CN)

(72) Inventor: Tie Li, Shenzhen (CN)

(21) Appl. No.: 16/876,099

(22) Filed: May 17, 2020

Related U.S. Application Data
(63) Continuation of application No. PCT/CN2019/076026, filed on Feb. 25, 2019.

(30) Foreign Application Priority Data
Oct. 12, 2018 (CN) 201811188145.3

(51) Int. Cl. F16F 1/377; F16F 15/08; F16F 1/36; F16F 1/37

(52) U.S. Cl. CPC F16F 1/377; F16F 15/08; F16F 2224/0225; F16F 1/37; F16F 2224/025; F16F 1/3605

(57) ABSTRACT

A damping pad is formed with a hollow portion, from an upper surface to a lower surface of the damping pad. The damping pad has at least two cross sections with different hollow proportions. The cross sections having different hollow proportions enable the damping pad to absorb vibrations of different frequencies and waveforms and of various combinations of different frequencies and waveforms, such that the damping pad achieves good absorption and damping of vibrations of various frequencies and waveforms and complex combinations thereof.

### CROSS REFERENCE TO RELATED APPLICATIONS

The present application is a continuation application of PCT/CN2019/076026, filed on Feb. 25, 2019 which claims the priority of Chinese patent application No. 201811188145.3 filed on Oct. 12, 2018, the entire contents of which are incorporated herein by reference.

### FIELD OF TECHNOLOGY

The present application relates to the field of vibration absorption and prevention, in particular to a damping pad.

### BACKGROUND TECHNOLOGY

In the prior art, the installations of some electrical appliances and machinery usually involve a damping pad at the base, so that the vibration of appliances or machinery will not be further transmitted or will be reduced through the damping of the damping pad, and most of the damping pads are solid or single-structure wooden strips, rubber strips and plastic strips etc. However, vibration frequencies and waveforms vary according to different electrical appliances and machinery, and even the same electrical appliance or machine has different vibration frequencies and waveforms under different working conditions (such as at different working power). It is difficult for a single solid material or structure to deal with vibrations of combinations of various frequencies and waveforms, and therefore the damping effect is poor.

### SUMMARY

The technical problem to be solved by this application is to damp the vibration of electrical appliances and machinery etc. which have multiple varying vibration frequencies.

In order to solve the above technical problem, the present application discloses a damping pad formed with a hollow portion, from an upper surface to a lower surface of the damping pad, the damping pad having at least two cross sections with different hollow proportions.

Further, the hollow proportions of the at least two cross sections with different hollow proportions show a continuous change.

Further, the hollow proportions of the at least two cross sections with different hollow proportions are 0-80%.

Further, the hollow proportions of the at least two cross sections with different hollow proportions show a gradient change.

Further, gradient levels of the gradient change have at least three levels.

Further, the hollow portion is a hollow hole located in the damping pad.

Further, the hollow portion is a circular hole, a square hole or an irregular hole distributed in the damping pad, and the depth of the circular hole, the square hole or the irregular hole shows a gradient change, an axial direction thereof is along a thickness direction of the damping pad.

Further, the hollow portion is a conical hole located in the damping pad, and an axial direction of the conical hole is along the thickness direction of the damping pad.

Further, the thickness of the damping pad is 0.1˜300 mm.

Further, the damping pad is made of EVA, rubber, silicone, polyurethane or foam.

The key idea of the damping pad disclosed in the present application is to provide a damping pad having different cross sections with different hollow proportions, so that the damping pad is applicable to vibrations of various frequencies and waveforms and combinations thereof. When the damping pad is mounted and in use, vibrations from electrical appliances and machinery are transmitted to the upper surface of the damping pad. If the hollow proportions in the cross sections of the damping pad are constant, the damping pad only has a good damping effect on the vibration of a specific frequency and waveform, considering the natural frequency property of an object. If the hollow proportions in the cross sections vary, different hollow proportions from the upper surface to the lower surface of the damping pad can correspond to different natural frequencies and waveforms, so that a better damping effect may be achieved for various frequencies and waveforms and complex combinations thereof.

### BRIEF DESCRIPTION OF THE DRAWINGS

The specific structure of the present application is described in detail below with reference to the drawings.

FIG. 1 is a cross-sectional view of a damping pad with conical holes viewing from a thickness direction;

FIG. 2 is a cross-sectional view taken along line A-A in FIG. 1;

FIG. 3 is a cross-sectional view taken along line B-B in FIG. 1;

FIG. 4 is a cross-sectional view of a damping pad with circular holes viewing from a thickness direction;

FIG. 5 is a cross-sectional view taken along line C-C in FIG. 4;

FIG. 6 is a cross-sectional view taken along line D-D in FIG. 4.

### DESCRIPTION OF THE EMBODIMENTS

In order to explain in detail the technical content, structural features, achieved objectives and effects of the present application, the following will be described in detail in conjunction with the embodiments and accompanying drawings.

### Embodiment 1

A damping pad is provided in an embodiment of the present application. The damping pad is formed with a hollow portion, from an upper surface to a lower surface of the damping pad, the damping pad having at least two cross sections with different hollow proportions, that is, the hollow proportions vary. The hollow proportion as used herein refers to the ratio of the area of the hollow portion to the entire cross-sectional area in a cross section. The hollow proportions of the at least two cross sections with different hollow proportions show a continuous change. The hollow proportions of the at least two cross sections with different hollow proportions are preferably 0-80%. The range of the hollow proportions determines the range of vibration frequencies that the damping pad can effectively absorb and damp, that is, the larger the range of the hollow proportions, the larger the range of vibration frequencies that can be effectively damped.

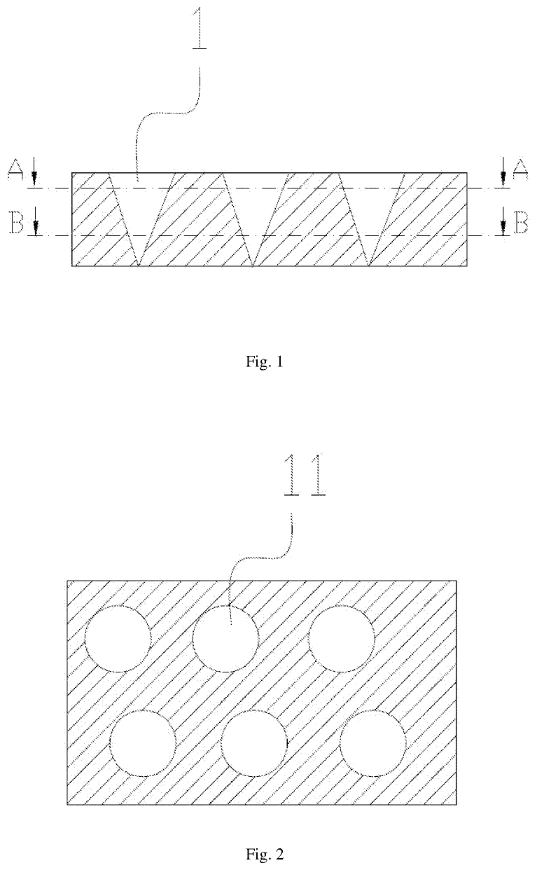

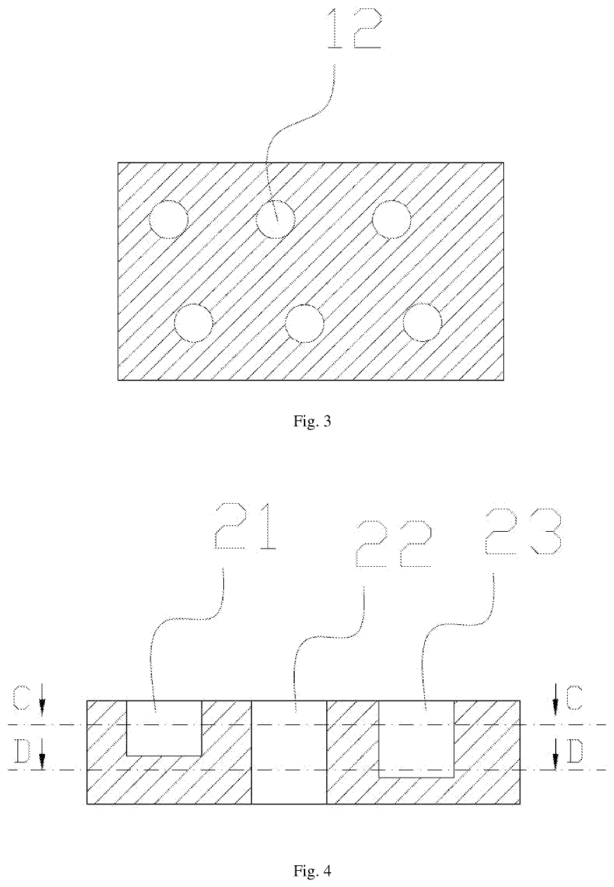

Specifically, the hollow portion is a hollow hole located in the damping pad, namely the hollow portion is formed by forming a hole. It may be preferably a conical hole in the damping pad, and the axial direction of the conical hole is along the thickness direction of the damping pad, and its conical degree may be 60 degrees. As shown in FIGS. 1, 2 and 3, the figures illustrate conical holes 1, a cross section 11 of the conical holes taken along line A-A, and another cross section 12 of the conical holes taken along line B-B. It can be seen from the figures that different cross sections correspond to different diameters, and the hollow proportions also vary. The diameter of the conical hole changes continuously, so that the hollow proportion in the cross section also changes continuously. Therefore, it can correspond to a continuous fixed frequency, so that it has excellent absorption and damping effect on the vibrations of a range of frequencies.

In addition, the thickness of the damping pad is 0.1˜300 mm. The material of the damping pad is an elastic material, preferably EVA, rubber, silicone, polyurethane or foam.

### Embodiment 2

A damping pad is provided in another embodiment of the present application. The damping pad is formed with a hollow portion, from an upper surface to a lower surface of the damping pad, the damping pad having at least two cross sections with different hollow proportions, that is, the hollow proportions vary. The hollow proportion as used herein refers to the ratio of the area of the hollow portion to the entire cross-sectional area in a cross section. The hollow proportions of the at least two cross sections with different hollow proportions show a gradient change. The gradient levels of the gradient change have at least three levels.

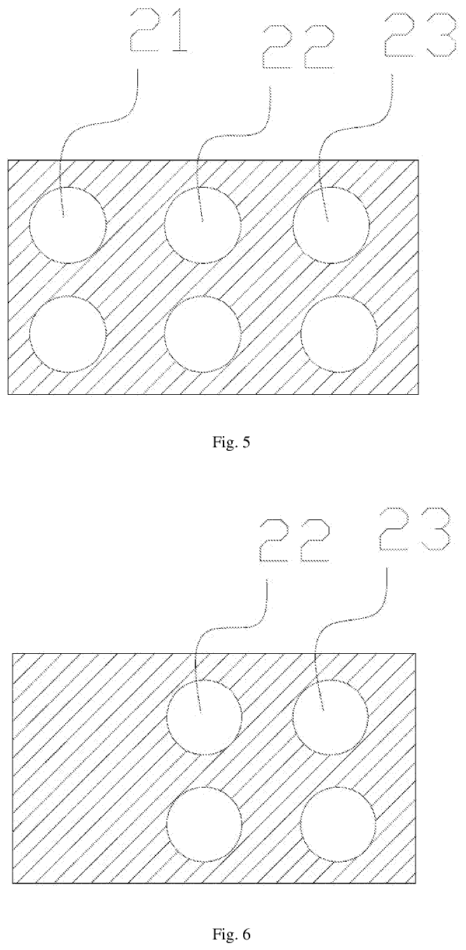

Specifically, the hollow portion is a hollow hole located in the damping pad. The hollow portion is a circular hole, a square hole or an irregular hole distributed in the damping pad, and the depth of the circular hole, the square hole or the irregular hole shows a gradient change, and an axial direction thereof is along a thickness direction of the damping pad. As shown in FIGS. 4, 5 and 6, hole 21, hole 22 and hole 23 have different hole depths. When a cross section is taken along line C-C, the corresponding hole 21, hole 22, and hole 23 are present in the cross section, and when a cross section is taken along line D-D, only hole 22 and hole 23 are present in the cross section, such that the hollow proportions in the two cross sections are different. That is, by designing different depths of the holes, different hollow proportions in different cross sections may be achieved, so as to correspond to different natural frequencies, and finally a better absorption and damping effect on the vibrations of different frequencies may be achieved.

In addition, the thickness of the damping pad is 0.1˜300 mm. The material of the damping pad is an elastic material, preferably EVA, rubber, silicone, polyurethane or foam.

For mechanical vibration, it often corresponds to a vibration frequency and waveform or a combination of multiple frequencies and waveforms at a specific point of time, and the frequency and waveform may also change with time, or may not change. This type of vibration will usually be transmitted, resulting in vibration at a certain frequency in other objects. Concerning the vibration itself, there is often vibration of a specific frequency and waveform that can be effectively damped or completely absorbed. Due to the limitation of the natural frequency, a conventional damping pad may often only have a good damping or absorption effect on the vibration of a certain frequency and waveform. However, the damping pad in the present application creatively designs cross sections having different hollow proportions, so that it can deal with various frequencies and waveforms or combinations thereof. When the damping pad is in use, a mechanical vibration is transmitted to the upper surface and further to the lower surface, and because of the change of the hollow proportions in the cross sections, even vibrations of different frequencies can always be effectively damped or completely absorbed in a particular cross section having a particular hollow proportion. Therefore, it has an excellent damping effect on the vibration of any frequency and waveform within the range.

Here, the terms “upper”, “lower”, “left”, “right”, “front”, and “rear” only represent their relative positions but not their absolute positions. The above are only examples of the present application, and therefore do not limit the scope of patent protection of the present application. Any equivalent structure or equivalent process transformation made by the description and the drawings, or directly or indirectly used in other related technical fields, shall fall within the scope of protection of the present application.

What is claimed is:

1. A damping pad, comprising:
a hollow portion formed on the damping pad, from an upper surface to a lower surface of the damping pad, the damping pad having at least two cross sections with different hollow proportions.

2. The damping pad according to claim 1, wherein
the hollow proportions of the at least two cross sections with different hollow proportions show a continuous change.

3. The damping pad according to claim 2, wherein
the hollow proportions of the at least two cross sections with different hollow proportions are 0-80%.

4. The damping pad according to claim 1, wherein
the hollow proportions of the at least two cross sections with different hollow proportions show a gradient change.

5. The damping pad according to claim 4, wherein
gradient levels of the gradient change have at least three levels.

6. The damping pad according to claim 1, wherein
the hollow portion is a hollow hole located in the damping pad.

7. The damping pad according to claim 6, wherein
the hollow portion is a circular hole, a square hole or an irregular hole distributed in the damping pad, the circular hole, the square hole or the irregular hole has a depth which shows a gradient change, and an axial direction of the circular hole, the square hole or the irregular hole is along a thickness direction of the damping pad.

8. The damping pad according to claim 6, wherein
the hollow portion is a conical hole located in the damping pad, and an axial direction of the conical hole is along a thickness direction of the damping pad.

9. The damping pad according to claim 1, wherein
the damping pad has a thickness of 0.1 mm˜300 mm.

10. The damping pad according to claim 1, wherein
the damping pad is made of EVA, rubber, silicone, polyurethane or foam.
